(19) United States
(12) Patent Application Publication
(10) Pub. No.: US 2019/0317263 A1
(43) Pub. Date: Oct. 17, 2019

(54) LIQUID CRYSTAL DISPLAY DEVICE

(71) Applicant: Samsung Display Co., Ltd., Yongin-si (KR)

(72) Inventors: Youn Ho Han, Seoul (KR); Seung In Baek, Seongnam-si (KR); Jung Hwan Yi, Hwaseong-si (KR); Mi Ra Gwon, Daejeon (KR); Young Eun Park, Seoul (KR); Su Jin Choi, Seoul (KR)

(21) Appl. No.: 16/379,229

(22) Filed: Apr. 9, 2019

(30) Foreign Application Priority Data
Apr. 16, 2018 (KR) 10-2018-0043966

(51) Int. Cl. F21V 8/00; G02F 1/1335

(52) U.S. Cl. CPC G02B 6/0026; G02B 6/005; G02B 6/0031; G02F 2201/121; G02F 1/133514; G02F 1/133528; G02F 2201/123; G02B 6/0065

(57) ABSTRACT

A liquid crystal display device includes a light guide plate, an optical film, a quantum dot film, a display panel, a light source unit, and an optical filter. The light guide plate includes a light incident surface and a light emission surface. The optical film is disposed in the light emission surface on the light guide plate, and has a first refractive index. The quantum dot film is disposed on the optical film. The display panel is disposed on the quantum dot film, and displays an image. The light source unit is spaced apart from the light incident surface of the light guide plate, and emits a light. The optical filter is disposed in the light incident surface such that the optical filter is spaced apart from the light source unit, and reflects a first light, which has an angle of incidence greater than a predetermined angle of incidence, among the light.

### CROSS-REFERENCE TO RELATED APPLICATION

This application claims priority from and the benefit of Korean Patent Applications No. 10-2018-0043966, filed on Apr. 16, 2018 which is hereby incorporated by reference for all purposes as if fully set forth herein.

### BACKGROUND

### Field

Exemplary embodiments of the invention relate generally to a liquid crystal display device and, more specifically, to a liquid crystal display device including an optical filter.

### Discussion of the Background

A flat panel display (“FPD”) device is widely used as a display device of an electronic device because the FPD device is lightweight and thin as compared to a cathode-ray tube (“CRT”) display device. Typical examples of the FPD device are a liquid crystal display (“LCD”) device and an organic light emitting diode (“OLED”) display device.

The LCD device applies voltage to a liquid crystal layer to change arrangement of the liquid crystal layer. Accordingly, various optical phenomenon, such as birefringence, optical rotation, dichroism, light scattering, or the like cause an optical change in the liquid crystal layer, thereby resulting in the display of an image on the display device. The LCD device may include a display panel, a light source unit that generates light, and a light guide plate that guides the light emitted from the light source unit to the display panel. The light source unit may be disposed adjacent to one side of the light guide plate, and may provide light to a light incident surface, which is defined as one side of the light guide plate. The light provided to the light guide plate may be totally reflected from an upper surface of the light guide plate, and may proceed to the light opposing surface of the light guide plate that is opposite to the light incident surface of the light guide plate. The total reflection light may be diffused by diffusion patterns disposed a lower surface of the light guide plate. However, the light might not be totally reflected in an upper surface of the light guide plate that is adjacent to the light incident surface of the light guide plate, and may be leaked through the upper surface of the light guide plate. Accordingly, light efficiency may be reduced.

The above information disclosed in this Background section is only for understanding of the background of the inventive concepts, and, therefore, it may contain information that does not constitute prior art.

### SUMMARY

Exemplary embodiments of the invention provide a liquid crystal display (“LCD”) device including an optical filter.

Additional features of the inventive concepts will be set forth in the description which follows, and in part will be apparent from the description, or may be learned by practice of the inventive concepts.

An exemplary embodiment of the invention provides an LCD device including a light guide plate, an optical film, a quantum dot film, a display panel, a light source unit, and an optical filter. The light guide plate includes a light incident surface and a light emission surface. The optical film is disposed in the light emission surface on the light guide plate, and has a first refractive index. The quantum dot film is disposed on the optical film. The display panel is disposed on the quantum dot film, and displays an image. The light source unit is spaced apart from the light incident surface of the light guide plate, and emits a light. The optical filter is disposed in the light incident surface such that the optical filter is spaced apart from the light source unit, and reflects a first light, which has an angle of incidence greater than a predetermined angle of incidence, among the light.

The optical filter may transmit a second light, which has an angle of incidence less than the predetermined angle of incidence, among the light.

The optical filter may include a first optical layer having the first refractive index and a second optical layer having a second refractive index that is greater than the first refractive index.

The optical filter may include first and second optical layers, and the first and second optical layers are repeatedly arranged such that the optical filter reflects the first light having an angle of reflection that is greater than the predetermined angle of incidence and transmits the second light having an angle of transmission that is less than the predetermined angle of incidence.

The optical filter may include a first surface facing the light source unit and a second surface facing the light guide plate, and the second surface of the optical filter may be in direct contact with the light incident surface of the light guide plate.

An angle between a reference line normal to the first surface of the optical filter and an incident line of the incident light may be defined as an angle of incidence of the light.

The light source unit may emit a blue light.

The light guide plate may be in direct contact with the optical film.

The LCD device may further include a reflection member surrounding the optical filter and the light source unit.

The reflection member may include a first reflection pattern and a second reflection pattern. The first reflection pattern may be disposed in a first surface of the light source unit. The second reflection pattern may be spaced apart from the light source unit, and may extend from an outer portion of the first reflection pattern in a direction, which is from the light source unit into the optical filter, such that the second reflection pattern is disposed to overlap at least a portion of the optical filter.

The reflection member may surround the light source unit and the optical filter such that a light emitted in the light source unit does not escape to an outside. After a first light reflected from the optical filter is reflected from the reflection member, the first light may be incident on the optical filter.

The optical filter may have a first surface facing the light source unit and a second surface facing the light guide plate, and the optical filter may include a base layer and a plurality of light absorbing layers penetrating the base layer in a direction from the first surface in to the second surface.

The light absorbing layers may be spaced apart from each other by a first distance, and a length of each of the light absorbing layers may be a second distance that is different from the first distance. The first and second distances may be calculated according to Equation below:

$$d \leq \frac{tan {θ}_{c}}{t}$$

wherein d corresponds to the first distance, t corresponds to the second distance, and θ_{c} corresponds to an angle incidence of light with respect to the first surface.

Each of the light absorbing layers may include a first side surface facing the light source unit and a second side surface facing the light guide plate, and a first side of the base layer and the second side surface of the light absorbing layer may be in direct contact with the light guide plate.

The LCD device may include a third reflection pattern disposed on the first side surface of each of the light absorbing layers and a reflection member surrounding the optical filter and the light source unit.

The light guide plate may have a second refractive index that is greater than the first refractive index.

The light guide plate may include a glass light guide plate.

The optical film may include quantum dots, and the quantum dots may include first quantum dot particles of a green and second quantum dot particles of a red.

The display panel may include a lower substrate, a pixel electrode disposed on the lower substrate, a liquid crystal layer disposed on the pixel electrode, a common electrode disposed on the liquid crystal layer, a color filter disposed on the common electrode, and an upper substrate disposed on the color filter.

The LCD device may further include a polarizing film disposed between the optical film and the display panel.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a perspective view illustrating a liquid crystal display (“LCD”) device in accordance with an exemplary embodiment of the invention.

FIG. 2 is a cross-sectional view taken along a line I-I′ of FIG. 1.

FIG. 3 is a cross-sectional view for describing a display panel included in the LCD device of FIG. 1.

FIG. 4 is a perspective view for describing an optical filter included in the LCD device of FIG. 1.

FIG. 5 is a partially enlarged cross-sectional view corresponding to region ‘A’ of FIG. 2.

FIG. 6 is a cross-sectional view illustrating an LCD device in accordance with an exemplary embodiment of the invention.

FIG. 7 is a cross-sectional view illustrating an LCD device in accordance with an exemplary embodiment of the invention

FIG. 8 is a cross-sectional view illustrating an LCD device in accordance with an exemplary embodiment of the invention.

### DETAILED DESCRIPTION

In the following description, for the purposes of explanation, numerous specific details are set forth in order to provide a thorough understanding of various exemplary embodiments of the invention. As used herein “embodiments” are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Hereinafter, exemplary embodiments of the present inventive concept will be explained in detail with reference to the accompanying drawings.

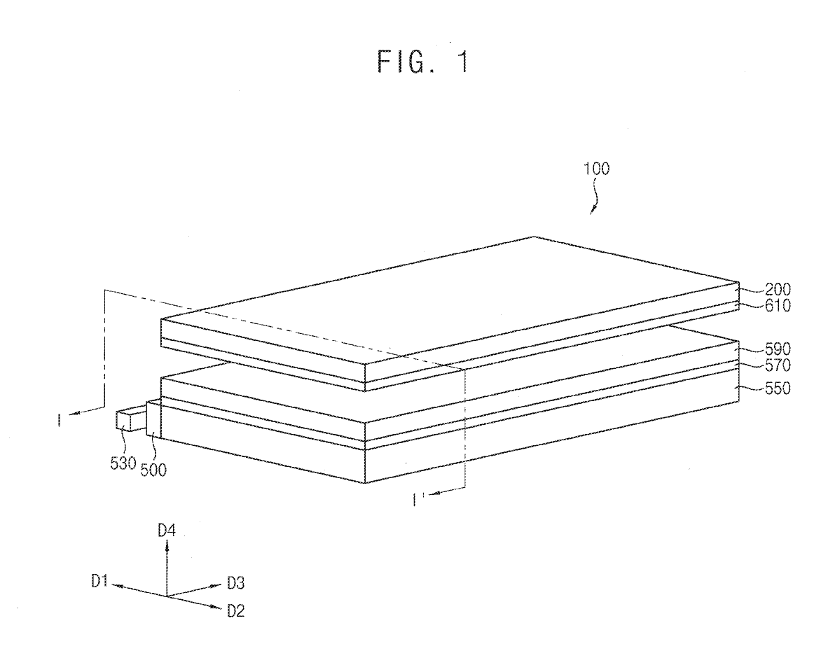

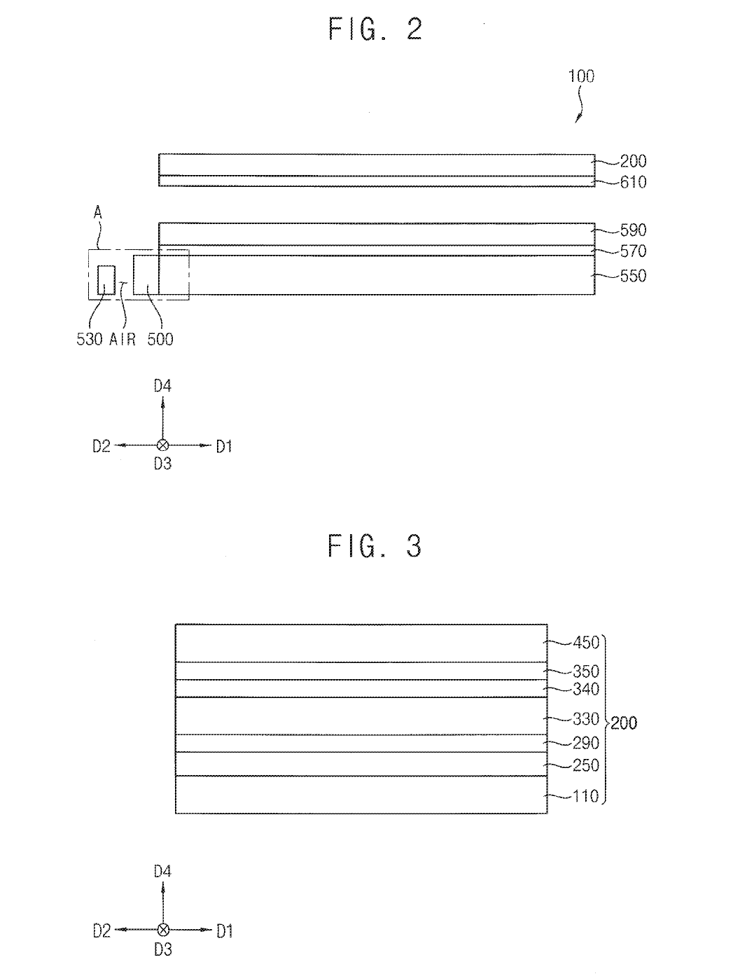

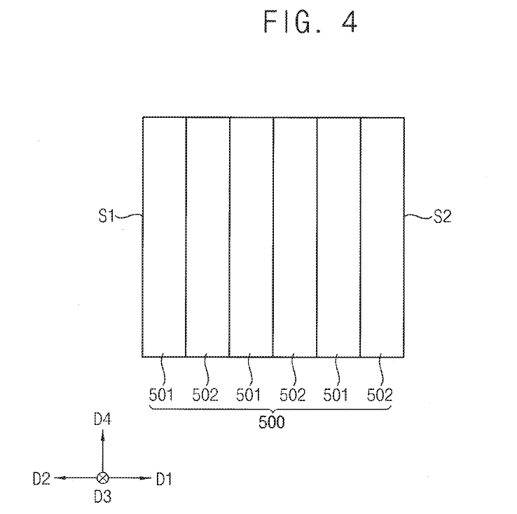

FIG. 1 is a perspective view illustrating a liquid crystal display (“LCD”) device in accordance with an exemplary embodiment, and FIG. 2 is a cross-sectional view taken along a line I-I′ of FIG. 1. FIG. 3 is a cross-sectional view for describing a display panel included in the LCD device of FIG. 1, and FIG. 4 is a perspective view for describing an optical filter included in the LCD device of FIG. 1.

Referring to FIGS. 1, 2, 3, and 4, an LCD device 100 may include a display panel 200, a polarizing film 610, a quantum dot film 590, an optical film 570, a light guide plate 550, a light source unit 530, an optical filter 500, etc. Here, the display panel 200 may display an image, and may include a lower substrate 110, a semiconductor element 250, a pixel electrode 290, a crystal layer 330, a common electrode 340, a color filter 350, an upper substrate 450, etc.

The light source unit 530 may be spaced apart from the optical filter 500 in a first direction D1 (e.g., a direction that is in parallel to an upper surface of the LCD device 100), and the optical filter 500 may be spaced apart from the light source unit 530 in a second direction D2 that is opposite to the first direction D1. Each of the light source unit 530 and the optical filter 500 may extend in a third direction D3 that is perpendicular to the first and second directions D1 and D2.

The optical filter 500 may include a first optical layer 501 and a second optical layer 502, and the light guide plate 550 may have a light incident surface and a light emission surface. In an exemplary embodiment, the optical filter 500 may reflect a light (e.g., a first light), which has an angle of incidence greater than a predetermined angle of incidence, among a light emitted from the light source unit 530, and transmit a light (e.g., a second light), which has an angle of incidence less than the predetermined angle of incidence, among the light. The LCD device 100 included in the optical filter 500 may serve as an LCD device where a light efficiency is relatively improved.

As illustrated in FIG. 3, the lower substrate 110 having transparent materials may be disposed. The lower substrate 110 may include a glass substrate or a plastic substrate.

The semiconductor element 250 may be disposed on the lower substrate 110. The semiconductor element 250 may include an active layer, a gate insulation layer, a gate electrode, an insulating interlayer, and source and drain electrodes. For example, the active layer may include an oxide semiconductor, an inorganic semiconductor (e.g., amorphous silicon, polysilicon, etc.), an organic semiconductor, etc. The gate insulation layer and the insulating interlayer may include a silicon compound, a metal oxide, etc. The gate electrode and the source and drain electrodes may include a metal, a metal alloy, metal nitride, conductive metal oxide, transparent conductive materials, etc. The semiconductor element 250 may be electrically connected to the pixel electrode 290.

The pixel electrode 290, the crystal layer 330, and the common electrode 340 may be disposed on the semiconductor element 250. For example, the crystal layer 330 may be disposed on the pixel electrode 290, and the common electrode 340 may be disposed on the crystal layer 330. Alternatively, the crystal layer 330 may be disposed on the common electrode 340, and the pixel electrode 290 may be disposed on the crystal layer 330. For example, each of the pixel electrode 290 and the common electrode 340 may include a metal, a metal alloy, metal nitride, conductive metal oxide, transparent conductive materials, etc, and the crystal layer 330 may include liquid crystal molecules. Here, an electric field may be formed between the pixel electrode 290 and the common electrode 340, and an arrangement of the liquid crystal molecules included in the crystal layer 330 may be changed according to the electric field.

The color filter 350 may be disposed on the common electrode 340. A light transmitting the crystal layer 330 may be emitted into an outside through the color filter 350. The color filter 350 may include at least one selected from a red color filter, a green color filter, and a blue color filter. Alternatively, the color filter 350 may include a yellow color filter, a cyan color filter, and a magenta color filter. The color filter 350 may include a photosensitive resin, color photoresist, etc.

The upper substrate 450 may be disposed on the color filter 350. The upper substrate 450 and the lower substrate 110 may include substantially the same materials. For example, the upper substrate 450 may include a glass substrate or a plastic substrate. Accordingly, the display panel 200 including the lower substrate 110, the semiconductor element 250, the pixel electrode 290, the crystal layer 330, the common electrode 340, the color filter 350, and the upper substrate 450 may be provided.

Referring again to FIGS. 1 through 4, the polarizing film 610 may be disposed under the display panel 200. The polarizing film 610 may concentrate a light transmitting the quantum dot film 590 in a fourth direction D4 (e.g., a direction that is perpendicular to the first, second, and third directions D1, D2, and D3, or a direction that is from the light guide plate 550 into the display panel 200). In addition, the light transmitting the polarizing film 610 may travel into the fourth direction D4, and may have a uniform luminance distribution. Further, the light may be provided to the display panel 200. For example, the polarizing film 610 may include a linearly-polarizing film, prism sheet, etc.

The quantum dot film 590 may be disposed under the polarizing film 610. In exemplary embodiments, the quantum dot film 590 may be in direct contact with the optical film 570, and may be spaced apart from the polarizing film 610. The quantum dot film 590 may include a plurality of quantum dots. The quantum dot film 590 may include quantum dots having different sizes depending on a type of the light source unit 530 to generate a white light. In exemplary embodiments, the light source unit 530 may generate a blue light, and the quantum dot film 590 may include first quantum dot particles each having a size that absorbs a light of a blue wavelength band and emits a light of a green wavelength band and second quantum dot particles each having a size that absorbs a light of a blue wavelength band and emits a light of a red wavelength band. The first and second quantum dot particles may absorb a blue light emitted from the light guide plate 550, and may convert the blue light into a light of a green wavelength band or a light of a red wavelength band. In addition, a portion of the blue light might not be absorbed in the first and second quantum dot particles. Accordingly, a white light may be generated by mixing the light of the blue, green, and red wavelengths in the quantum dot film 590. Alternatively, the quantum dot film 590 may further include a scatter, a dispersing agent, a base material, etc. In addition, the LCD device 100 may further include a protection film surrounding the quantum dot film 590. As the protection film blocks moisture or water permeating into the quantum dot film 590, the protection film may protect the quantum dot film 590. For example, the protection film may be formed of a single layer having an inorganic insulation layer including silicon compound. Alternatively, the protection film layer may be formed of a plurality of layers composed of a first inorganic insulation layer including silicon compound, organic insulation layer including monomer, polymer, etc, and a second inorganic insulation layer.

The optical film 570 may be disposed under the quantum dot film 590. In exemplary embodiments, the optical film 570 may be disposed on the light emission surface of the light guide plate 550, and may be in direct contact with the light guide plate 550. In addition, the optical film 570 may have a first refractive index. For example, the first refractive index may correspond to a relatively small refractive index, and may be in a range between about 1.4 and about 2. In exemplary embodiments, a refractive index of the optical film 570 may be about 1.3. The optical film 570 may include insulation materials, such as silicon compound, metal oxide, etc.

The light guide plate 550 may be disposed under the optical film 570. As described above, the light guide plate 550 may have the light incident surface and the light emission surface. The optical filter 500 may be disposed in the light incident surface, and the optical film 570 may be disposed in the light emission surface.

The light guide plate 550 may include a plastic light guide plate, a glass light guide plate, etc. In exemplary embodiments, the light guide plate 550 may include the glass light guide plate. In addition, the light guide plate 550 may have a second refractive index that is greater than the first refractive index. For example, the second refractive index may correspond to a relatively large refractive index, and may be in a range between about 1.5 and about 3. In exemplary embodiments, a refractive index of the light guide plate 550 may be about 1.5. For example, in a process for manufacturing an LCD device, when the LCD device has a plastic light guide plate, it is difficult that a quantum dot film is formed directly on the plastic light guide plate, and air (e.g., a layer having a low refractive index) should be interposed between the plastic light guide plate and the quantum dot film such that a light emitted from a light source unit is totally reflected inside the plastic light guide plate. Thus, a support member, etc., may be further disposed in the LCD device such that the plastic light guide plate and the quantum dot film are spaced apart from each other. In this case, a thickness of the LCD device may be relatively increased, and a manufacturing cost of the LCD device may be relatively increased.

On the other hand, in exemplary embodiments, because the LCD device 100 includes the glass light guide plate, the optical film 570 (e.g., a layer having a low refractive index) may be formed directly on the light guide plate 550, and the quantum dot film 590 may be formed directly on the optical film 570. Accordingly, a thickness of the LCD device 100 may be decreased, and a manufacturing cost of the LCD device 100 may be reduced.

Alternatively, the LCD device 100 may further include diffusion patterns disposed under the light guide plate 550. For example, a light emitted from the light source unit 530 may be transmitted inside the light guide plate 550, and a portion of the light may be scattered from (or diffused by) the diffusion patterns. The scattered light may be emitted from the light guide plate 550 in the fourth direction D4.

The light source unit 530 may be located to be spaced apart from the light incident surface of the light guide plate 550. In addition, the light source unit 530 may be spaced apart from the optical filter 500 by the second direction D2, and may extend parallel to the optical filter 500 along the third direction D3. The light source unit 530 may emit light. In other words, the light source unit 530 may provide light to the display panel 200. For example, light emitted from the light source unit 530 in the first direction D1 may travel into the light guide plate 550 through the optical filter 500. The light traveling into the light guide plate 550 may be emitted from the light guide plate 550 in the third direction D3, and then the light emitted form the light guide plate 550 may transmit the optical film 570, the quantum dot film 590, and the polarizing film 610. The light transmitting the polarizing film 610 may be provided to the display panel 200. In exemplary embodiments, the light source unit 530 may emit a blue light. Alternatively, the LCD device 100 may further include a support member to fix the light source unit 530.

The optical filter 500 may be disposed between the light source unit 530 and the light guide plate 550. In exemplary example embodiments, the optical filter 500 may have a first surface S1 facing the light source unit 530 and a second surface S2 facing the light guide plate 550, and the second surface S2 may be in direct contact with the light incident surface of the light guide plate 550. In addition, the optical filter 500 may reflect a first light, which is greater than a predetermined angle of incidence, among a light emitted from the light source unit 530, and may transmit a second light, which is less than the predetermined angle of incidence, among the light. Here, the first light may be different from the second light. For example, the optical filter 500 may be Distributed Bragg Reflector (“DBR”). As illustrated in FIG. 4, the optical filter 500 may include the first optical layer 501 having the first refractive index and the second optical layer 502 having a second refractive index. For example, the optical filter 500 may have a configuration where the first optical layer 501 and the second optical layer 502 are repeatedly and alternately disposed. In other words, the number of the first and second optical layers 501 and 502 may be determined such that the optical filter 500 reflects a first light greater than the predetermined angle of incidence and transmits a second light less than the predetermined angle of incidence.

The first optical layer 501 may include silicon compound, metal oxide, etc that have the first refractive index, and the second optical layer 502 may include silicon compound, metal oxide, etc that have the second refractive index. Each of the first optical layer 501 and the second optical layer 502 may include silicon oxide (“SiOₓ”), silicon nitride (“SiNₓ”), silicon oxynitride (“SiOₓN_{y}”), silicon oxycarbide (“SiOₓC_{y}”), silicon carbon nitride (“SiCₓN_{y}”), aluminum oxide (“AlOₓ”), aluminum nitride (“AlNₓ”), tantalum oxide (“TaOₓ”), hafnium oxide (“HfOₓ”), zirconium oxide (“ZrOₓ”), titanium oxide (“TiOₓ”), indium zinc oxide (“IZO”), indium tin oxide (“ITO”), etc.

For example, in an LCD device without the optical filter 500, when a light emitted from the light source unit 530 transmit the light incident surface of the light guide plate 550 at the predetermined angle of incidence or more, the light might not be totally reflected in a portion that is adjacent to the light incident surface of the light guide plate 550 (or the light emission surface that is adjacent to the light incident surface of the light guide plate 550), and may be emitted from the light guide plate 550 in the fourth direction D4 (or may be leaked through the light emission surface that is adjacent to the light incident surface of the light guide plate 550). In this case, light efficiency may be reduced.

In exemplary embodiments, as the LCD device 100 include the optical filter 500, the optical filter 500 may reflect a first light greater than the predetermined angle of incidence and transmit a second light less than the predetermined angle of incidence. Accordingly, a light emitted in a portion that is located adjacent to the light incident surface of the light guide plate 550 may be relatively decreased.

In some exemplary embodiments, the first optical layer 501 may have the second refractive index, and the second optical layer 502 may have the first refractive index.

In exemplary embodiments, the optical filter 500 includes six layers, but the inventive concepts are not limited thereto. For example, the optical filter 500 may include two, four, or six or more layers.

In addition, the LCD device 100 may further include function layers (e.g., an optical clear adhesive (“OCA”), a pressure sensitive adhesive (“PSA”), UV resin, etc) disposed on the first and second surfaces S1 and S2 of the optical filter 500.

Further, in some exemplary embodiments, the optical filter 500 may be in direct contact with the light source unit 530.

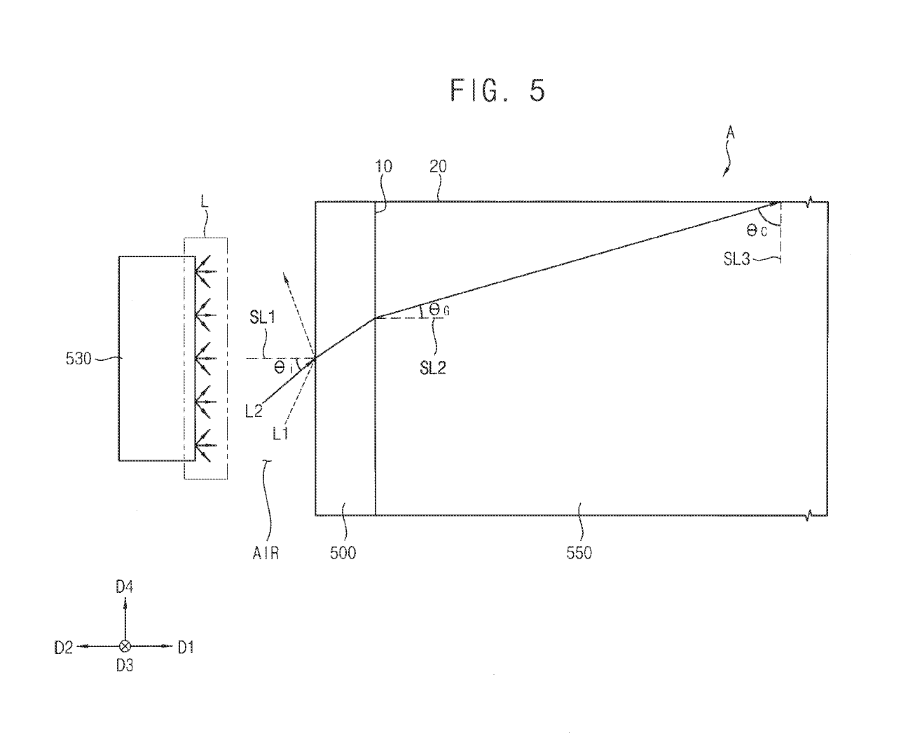

FIG. 5 is a partially enlarged cross-sectional view corresponding to region ‘A’ of FIG. 2. For example, FIG. 5 illustrates that after a portion among a light emitted from the light source unit 530 transmits air (e.g., refractive index is 1), the portion among a light emitted from the light source unit 530 is reflected from the optical filter 500. In addition, FIG. 5 illustrates that after a remaining portion of the light transmits the air and the optical filter 500, the remaining portion of the light travels inside the light guide plate 550 (e.g., refractive index is 1.5). Here, the light guide plate 550 may have a light incident surface 10 and a light emission surface 20.

Referring to FIGS. 2, 4, and 5, a light L may be emitted from the light source unit 530. When the light L emitted from the light source unit 530 reaches the first surface S1 of the optical filter 500, the light L may be separated into a first light L1 and a second light L2. Here, the first light L1 may be incident on the first surface S1 of the optical filter 500 at an angle θᵢ or more (e.g., an angle greater than the angle θᵢ) with respect to a first reference line SL1 normal to the first surface S1 the optical filter 500, and the second light L2 may be incident on the first surface S1 of the optical filter 500 in the angle θᵢ or less (e.g., an angle equal to or less than the angle θᵢ) with respect to the first reference line SL1. In other words, an angle between the first reference line SL1 normal to the first surface S1 of the optical filter 500 and an incident line (e.g., the first light L1 and the second light L2) of the incident light may be defined as the angle θᵢ that is an angle of incidence of the light.

In exemplary embodiments, the optical filter 500 may be manufactured such that the optical filter 500 reflects the first light L1, which is greater than the angle of incidence θᵢ with respect to the first reference line SL1, incident on the first surface S1 and transmits the second light L2, which is less than the angle of incidence θᵢ with respect to the first reference line SL1, incident on the first surface S1. For example, in a process for manufacturing the optical filter 500, refractive indexes of the first and second optical layers 501 and 502 and the stack number of the first and second optical layers 501 and 502 may be determined based on a Bragg's law such that the optical filter 500 reflects the first light L1 incident on the first surface S1 and transmits the second light L2 incident on the first surface S1. In addition, the angle of incidence θᵢ may depend on the refractive index of the optical film 570. For example, as the refractive of the optical film 570 is changed, the angle of incidence θᵢ may be changed.

As illustrated in FIG. 5, after the first light L1 greater than the angle of incidence θᵢ is incident on the first surface S1 of the optical filter 500, the first light L1 may be reflected from the optical filter 500. On the other hand, after the second light L2 less than the angle of incidence θᵢ is incident on the first surface S1 of the optical filter 500, the second light L2 may be transmitted inside the optical filter 500 (e.g., the second light L2 transmitted inside the optical filter 500 is refracted). The second light L2 transmitted inside the optical filter 500 may be incident on the light incident surface 10 of the light guide plate 550, and then the second light L2 may reach the light emission surface 20 of the light guide plate 550 at an angle θ_{G}. Here, an angle of incidence of the second light L2 with respect to a second reference line SL2 normal to the light incident surface 10 of the light guide plate 550 (or the second surface S2 of the optical filter 500) may be defined as the angle of incidence θ_{G}, and an angle of incidence of the second light L2 with respect to a third reference line SL3 normal to the light emission surface 20 of the light guide plate 550 may be defined as the angle of incidence θ_{C}. In addition, the angle of incidence θ_{C} may correspond to a total reflection angle of an interface of the light guide plate 550 and the optical film 570. For example, when an angle of incidence of the second light L2 is equal to or less than θ_{C}, the second light L2 may be totally reflected inside the light guide plate 550.

Because the LCD device 100 in accordance with exemplary embodiments includes the optical filter 500, the optical filter 500 may reflect the first light L1, which has an angle of incidence that is greater than the angle of incidence θᵢ, incident on the first surface S1 and transmit the second light L2, which has an angle of incidence that is less than the angle of incidence θᵢ, incident on the first surface S1. Accordingly, because the second light L2 is transmitted only inside the light guide plate 550, the second light L2 may be totally reflected, and a light leakage phenomenon may be relatively reduced at a portion that is adjacent to the light incident surface 10 of the light guide plate 550.

Table 1 is a table showing an angle change of an angle of incidence θᵢ as a refractive index of an optical film is changed.

TABLE 1

| Refractive index of optical film | θ_{C} | θ_{G} | θᵢ |
|---|---|---|---|
| 1.3 | 60.07 | 29.93 | 48.45 |
| 1.25 | 56.44 | 33.56 | 56.01 |
| 1.2 | 53.13 | 36.87 | 64.16 |

Referring to FIGS. 2, 4, 5, and Table 1, a light L may be emitted from the light source unit 530. A first light L1 among the light L travels through air, and then the first light L1 may be reflected from the optical filter 500. A second light L2 among the light L travels through the air, and then may transmit the optical filter 500.

When a refractive index of the optical film 570 is about 1.3, the optical filter 500 may reflect the first light L1, which has an angle of incidence greater than 48.45 degrees, incident on the first surface S1 of the optical filter 500 and may transmit the second light L2, which has an angle of incidence 48.45 degrees or less, incident on the first surface S1 of the optical filter 500. In this case, the second light L2 transmitting through the optical filter 500 may transmit through the light incident surface 10 to the light guide plate 550 (or the second surface S2 of the optical filter 500) at an angle of incidence 23.93 degrees or less. In addition, the second light L2 transmitting through the light guide plate 550 may be reflected from the light emission surface 20 of the light guide plate 550 at an angle of incidence 60.07 degrees or less. Here, the angle of incidence 60.07 degrees may correspond to a maximum total reflection angle of the light guide plate 550. That is, when a refractive index of the optical film 570 is about 1.3 and a refractive index of the light guide plate 550 is about 1.5, the optical filter 500 may be properly manufactured such that the optical filter 500 reflects a light, which has an angle of incidence greater than about 48.45 degrees and transmits a light, which has an angle of incidence of about 48.45 degrees or less.

Accordingly, when the refractive index of the optical film 570 is about 1.3 and the refractive index of the light guide plate 550 is about 1.5, a light leakage phenomenon may be relatively reduced at a portion that is adjacent to the light incident surface 10 of the light guide plate 550 because the optical filter 500 reflects a light, which has an angle of incidence greater than about 48.45 degrees and transmits a light, which has an angle of incidence about 48.45 degrees or less.

In addition, when a refractive index of the optical film 570 is about 1.25, the optical filter 500 may reflect the first light L1, which has an angle of incidence greater than 56.01 degrees, incident on the first surface S1 of the optical filter 500 and may transmit the second light L2, which has an angle of incidence of 56.01 degrees or less, incident on the first surface S1 of the optical filter 500. In this case, the second light L2 transmitting through the optical filter 500 may transmit through the light incident surface 10 the light guide plate 550 (or the second surface S2 of the optical filter 500) at an angle of incidence of 33.56 degrees or less. In addition, the second light L2 transmitting through the light guide plate 550 may be reflected from the light emission surface 20 of the light guide plate 550 at an angle of incidence of 56.44 degrees or less. Here, the angle of incidence 56.44 degrees may correspond to a maximum total reflection angle of the light guide plate 550. That is, when a refractive index of the optical film 570 is about 1.25 and a refractive index of the light guide plate 550 is about 1.5, the optical filter 500 may be properly manufactured such that the optical filter 500 reflects a light, which is an angle of incidence about 56.01 degrees above and transmits a light, which is an angle of incidence about 56.01 degrees or less.

Accordingly, when the refractive index of the optical film 570 is about 1.25 and the refractive index of the light guide plate 550 is about 1.5, a light leakage phenomenon may be relatively reduced at a portion that is adjacent to the light incident surface 10 of the light guide plate 550 because the optical filter 500 reflects a light, which has an angle of incidence greater than about 56.01 degrees and transmits a light, which has an angle of incidence about 56.01 degrees or less.

Further, when a refractive index of the optical film 570 is about 1.2, the optical filter 500 may reflect the first light L1, which has an angle of incidence greater than 64.16 degrees, incident on the first surface S1 of the optical filter 500 and may transmit the second light L2, which has an angle of incidence of 64.16 degrees or less, incident on the first surface S1 of the optical filter 500. In this case, the second light L2 transmitting through the optical filter 500 may transmit through the light incident surface 10 the light guide plate 550 (or the second surface S2 of the optical filter 500) at an angle of incidence of 36.87 degrees or less. In addition, the second light L2 transmitting through the light guide plate 550 may be reflected from the light emission surface 20 of the light guide plate 550 at an angle of incidence 53.13 degrees or less. Here, the angle of incidence 53.13 degrees may correspond to a maximum total reflection angle of the light guide plate 550. That is, when a refractive index of the optical film 570 is about 1.2 and a refractive index of the light guide plate 550 is about 1.5, the optical filter 500 may be properly manufactured such that the optical filter 500 reflects a light, which is an angle of incidence greater than about 64.16 degrees and transmits a light, which has an angle of incidence of about 64.16 degrees or less.

Accordingly, when the refractive index of the optical film 570 is about 1.2 and the refractive index of the light guide plate 550 is about 1.5, a light leakage phenomenon may be relatively reduced at a portion that is adjacent to the light incident surface 10 of the light guide plate 550 because the optical filter 500 reflects a light, which has an angle of incidence greater than about 64.16 degrees and transmits a light, which has an angle of incidence of about 64.16 degrees or less.

In this way, the optical filter 500 may be readily manufactured such that the optical filter 500 reflects an incident light greater than a predetermined angle of incidence and transmits an incident light less than the predetermined angle of incidence.

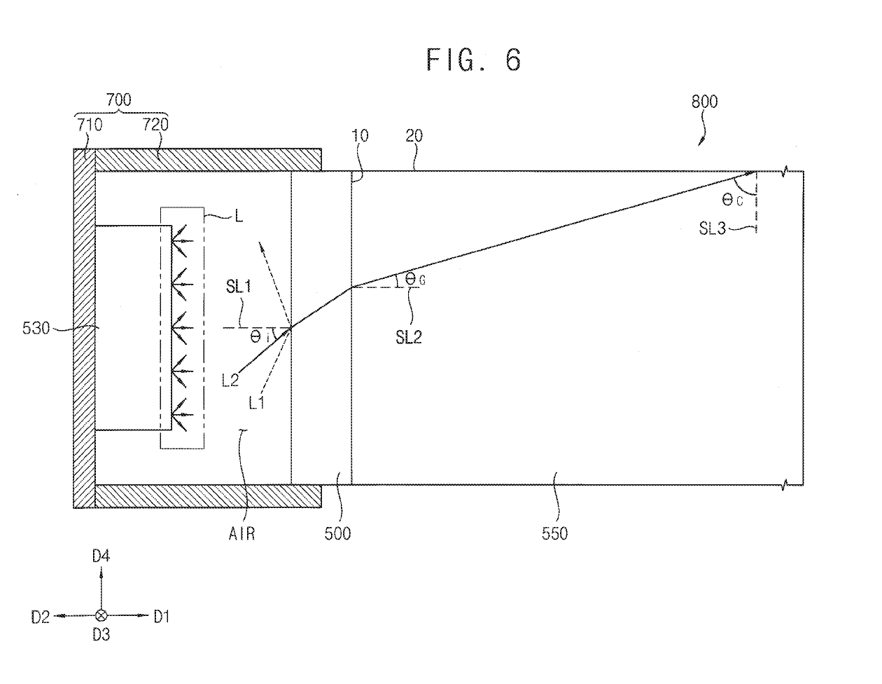

FIG. 6 is a cross-sectional view illustrating an LCD device in accordance with exemplary embodiments. An LCD device 800 illustrated in FIG. 6 may have a configuration substantially the same as or similar to that of an LCD device 100 described with reference to FIGS. 1 through 5 except for a reflection member 700. In FIG. 6, detailed descriptions for elements that are substantially the same as or similar to elements described with reference to FIGS. 1 through 5 may not be repeated.

Referring to FIGS. 1 through 6, an LCD device 800 may include a display panel 200, a polarizing film 610, a quantum dot film 590, an optical film 570, a light guide plate 550, a light source unit 530, an optical filter 500, a reflection member 700, etc. Here, the light source unit 530 may be spaced apart from the optical filter 500 by a first direction D1, and the optical filter 500 be spaced apart from the light source unit 530 by a second direction D2 that is opposite to the first direction D1. Each of the light source unit 530 and the optical filter 500 may extend in a third direction D3 that is perpendicular to the first and second directions D1 and D2. In addition, the reflection member 700 may include a first reflection pattern 710 and a second reflection pattern 720.

The optical filter 500 may include a first optical layer 501 and a second optical layer 502, and the light guide plate 550 may have a light incident surface 10 and a light emission surface 20. In exemplary embodiments, the optical filter 500 may reflect a light (e.g., a first light), which has an angle of incidence greater than a predetermined angle of incidence, among a light emitted from the light source unit 530 and transmit a light (e.g., a second light), which has an angle of incidence less than a predetermined angle of incidence, among the light. The LCD device 800 included in the optical filter 500 may serve as an LCD device where a light efficiency is relatively improved.

The reflection member 700 may be disposed to surround the light source unit 530 and the optical filter 500. Here, the light source unit 530 may have a first surface and a second surface. The first surface may be in contact with the first reflection pattern 710, and the second surface may face a first surface S1 of the optical filter 500. That is, the first surface of the light source unit 530 may be opposite to the second surface of the light source unit 530.

The first reflection pattern 710 may be disposed in the first surface of the light source unit 530. The first reflection pattern 710 may extend in the third direction D3 and the fourth direction D4, and a distance in the fourth direction D4 of the first reflection pattern 710 may be greater than a distance in the fourth direction D4 of the light source unit 530.

The second reflection pattern 720 may be spaced apart from upper and lower surfaces of the light source unit 530 (e.g., a surface located between the first surface and the second surface), and may extend from an outer portion of the first reflection pattern 710 by the first direction D1. The second reflection pattern 720 may be disposed to overlap at least a portion of the optical filter 500. In other words, the reflection member 700 may completely surround the light source unit 530 and the optical filter 500 such that a light L emitted from the light source unit 530 does not escape to an outside.

The reflection member 700 may include materials capable of reflecting a light. For example, the reflection member 700 may include a metal, an alloy such as gold (Au), silver (Ag), aluminum (Al), platinum (Pt), nickel (Ni), titanium (Ti), palladium (Pd), magnesium (Mg), calcium (Ca), lithium (Li), chromium (Cr), tantalum (Ta), tungsten (W), copper (Cu), molybdenum (Mo), scandium (Sc), neodymium (Nd), iridium (Jr), an alloy of aluminum, an alloy of silver, an alloy of copper, an alloy of molybdenum.

Because the LCD device 800 includes the reflection member 700, the first light L1 may be reflected form the reflection member 700 after the first light L1 having an angle of incidence greater than a predetermined angle of incidence is reflected from the optical filter 500. The first light L1 reflected from the reflection member 700 may be incident again on the optical filter 500. Accordingly, compared to the LCD device 100, a light efficiency of the LCD device 800 may be relatively increased.

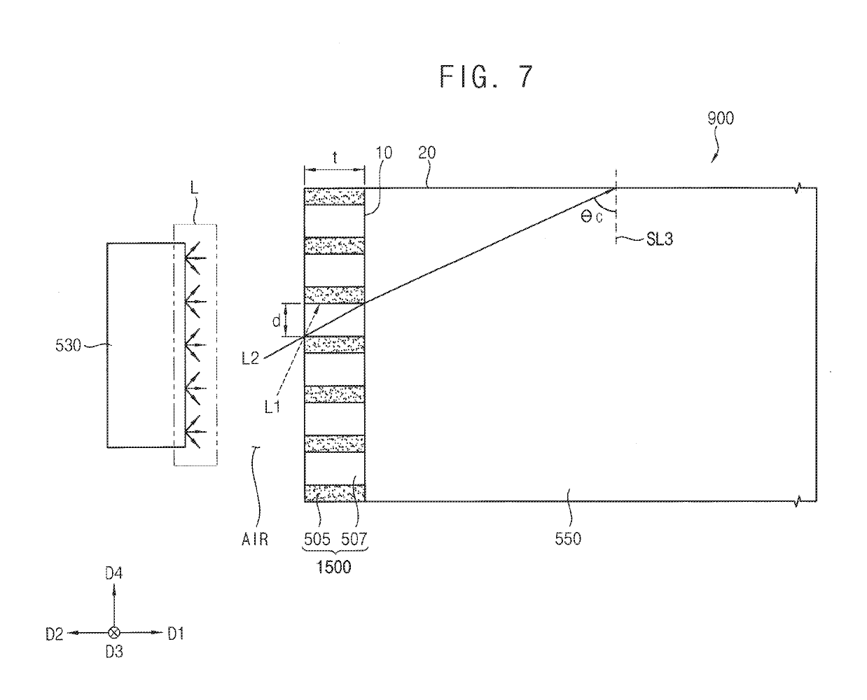

FIG. 7 is a cross-sectional view illustrating an LCD device in accordance with exemplary embodiments. An LCD device 900 illustrated in FIG. 7 may have a configuration substantially the same as or similar to that of an LCD device 100 described with reference to FIGS. 1 through 5 except for an optical filter 1500. In FIG. 7, detailed descriptions for elements that are substantially the same as or similar to elements described with reference to FIGS. 1 through 5 may not be repeated.

Referring to FIGS. 1 through 5 and 7, an LCD device 900 may include a display panel 200, a polarizing film 610, a quantum dot film 590, an optical film 570, a light guide plate 550, a light source unit 530, an optical filter 1500, etc. Here, the optical filter 1500 may include a base layer 507 and light absorbing layers 505.

The optical filter 1500 may be disposed between the light source unit 530 and the light guide plate 550. In exemplary embodiments, the optical filter 1500 may have a first surface S1 facing the light source unit 530 and a second surface S2 facing the light guide plate 550, and the second surface S2 may be in direct contact with a light incident surface 10 of the light guide plate 550.

As illustrated in FIG. 7, the optical filter 1500 may include the base layer 507 and the light absorbing layers 505 penetrating the base layer 507 in a direction from the first surface S1 into the second surface S2 (e.g., a first direction D1).

In exemplary embodiments, the optical filter 1500 may reflect a first light L1, which has an angle of incidence greater than a predetermined angle of incidence, among a light emitted from the light source unit 530 and transmit a second light L2, which has an angle of incidence less than a predetermined angle of incidence, among the light.

In addition, the base layer 507 may include substantially transparent insulation materials. For example, the base layer 507 may include glass, polymer, etc. Each of the light absorbing layers 505 may include a black matrix so as to absorb the first light L1. The black matrix may include black materials. The black materials capable of being used as the black matrix may include carbon black, phenylene black, aniline black, cyanine black, nigrosine acid black, black resin, etc.

For example, in a process for forming the optical filter 1500, a plurality the light absorbing layers 505 may be formed by penetrating the base layer 507 after the base layer 507 is formed as basic materials. The light absorbing layers 505 may be spaced apart from each other by a first distanced. Here, a length of each of the light absorbing layers 505 in the first direction D1 of the light absorbing layers 505 may be a second distance t.

In some exemplary embodiments, in a process for forming the optical filter 1500, the base layers 507 each having a width of the first distance d may be formed in the fourth direction D4 on the light absorbing layer 505 after the light absorbing layers 505 each having a length of the second distance t is formed. The optical filter 1500 may be formed by forming repeatedly the light absorbing layers 505 and the base layers 507. Here, because each of the base layers 507 has a width of the first distance d, a distance between adjacent two light absorbing layers 505 among the light absorbing layers 505 may be the first distance d.

In exemplary embodiments, the first distance d and the second distance t may be calculated according to the following Equation.

$$d \leq \frac{tan {θ}_{c}}{t} , \qquad [ Equation ]$$

wherein d corresponds to the first distance d, t corresponds to the second distance t, and θ_{c} corresponds to a second light L2 angle of incidence with respect to the first surface S1. For example, θ_{c} may be defined as an angle of incidence of the second light L2 with respect to the third reference line SL3 that is normal to the light emission surface 20 of the light guide plate 550.

The angle of incidence θ_{C} may correspond to a total reflection angle of an interface of the light guide plate 550 and the optical film 570. In other words, the angle of incidence θ_{C} may correspond to a maximum total reflection angle of the light guide plate 550. That is, the first light L1 having an angle of incidence greater than the angle of incidence θ_{C} may be absorbed in the light absorbing layers 505, and the second light L2 having an angle of incidence less than the angle of incidence θ_{C} may be totally reflected in the light guide plate 550

In exemplary embodiments, a distance of the length in the first direction D1 of the base layers 507 is identical to a distance of the length in the first direction D1 of the light absorbing layers 505, but the inventive concepts are not limited thereto. For example, in some exemplary embodiments, a distance of the length in the first direction D1 of the base layers 507 is greater than a distance of the length in the first direction D1 of the light absorbing layers 505.

Because the LCD device 900 includes the optical filter 1500, the optical filter 1500 may absorb the first light L1, which has an angle of incidence greater than the angle of incidence θ_{C}, incident on the first surface S1 and transmit the second light L2, which has an angle of incidence less than the angle of incidence θ_{C}, incident on the first surface S1. Accordingly, because the second light L2 is transmitted only inside the light guide plate 550, the second light L2 may be totally reflected, and a light leakage phenomenon may be relatively reduced at a portion that is adjacent to the light incident surface 10 of the light guide plate 550.

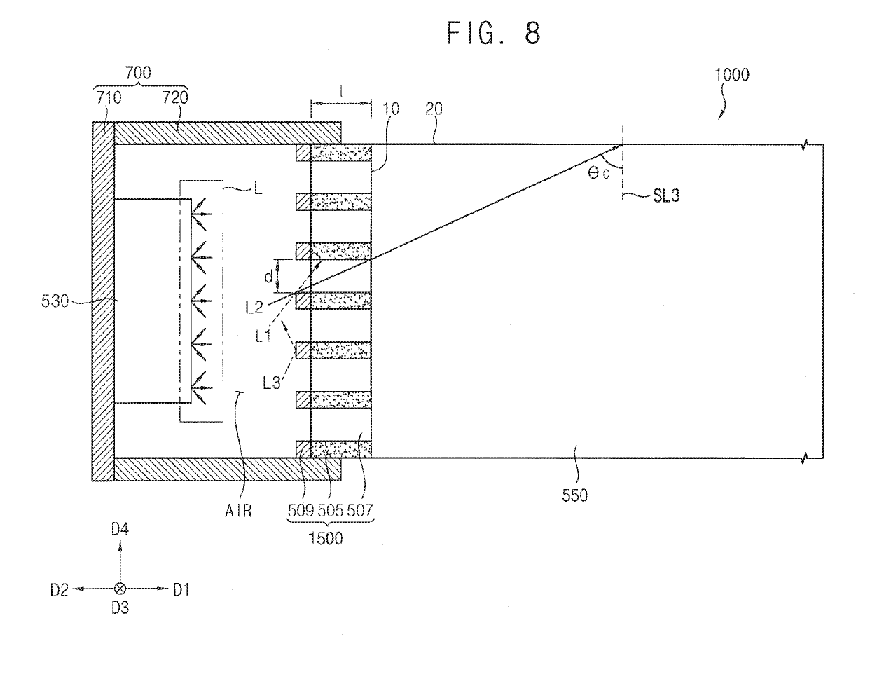

FIG. 8 is a cross-sectional view illustrating an LCD device in accordance with exemplary embodiments. An LCD device 1000 illustrated in FIG. 8 may have a configuration substantially the same as or similar to that of LCD devices 800 and 900 described with reference to FIGS. 6 and 7 except for an optical filter 1500. In FIG. 8, detailed descriptions for elements that are substantially the same as or similar to elements described with reference to FIGS. 6 and 7 may not be repeated.

Referring to FIGS. 6, 7, and 8, an LCD device 1000 may include a display panel 200, a polarizing film 610, a quantum dot film 590, an optical film 570, a light guide plate 550, a light source unit 530, an optical filter 1500, a reflection member 700, etc. Here, the reflection member 700 may include a first reflection pattern 710 and a second reflection pattern 720, and the optical filter 1500 may include a light absorbing layers 505, a base layer 507, and a third reflection pattern 509.

The reflection member 700 may be disposed to surround the light source unit 530 and the optical filter 500. Here, the light source unit 530 may have a first surface and a second surface.

The first reflection pattern 710 may be disposed in the first surface of the light source unit 530. The second reflection pattern 720 may be spaced apart from upper and lower surfaces of the light source unit 530, and may extend from an outer portion of the first reflection pattern 710 by the first direction D1. The second reflection pattern 720 may be disposed to overlap at least a portion of the optical filter 500. In other words, the reflection member 700 may completely surround the light source unit 530 and the optical filter 500 such that a light L emitted from the light source unit 530 does not escape to an outside.

The optical filter 1500 may be disposed between the light source unit 530 and the light guide plate 550. In example embodiments, the optical filter 1500 may have a first surface S1 facing the light source unit 530 and a second surface S2 facing the light guide plate 550, and the second surface S2 may be in direct contact with a light incident surface 10 of the light guide plate 550.

The optical filter 1500 may include the base layer 507, the light absorbing layers 505 penetrating the base layer 507 in a direction from the first surface S1 into the second surface S2 (e.g., a first direction D1), and the third reflection pattern 509 disposed to overlap the light absorbing layers 505 on the first surface S1.

The optical filter 1500 may absorb a first light L1, which has an angle of incidence greater than a predetermined angle of incidence, among a light emitted from the light source unit 530 and transmit a second light L2, which has an angle of incidence less than a predetermined angle of incidence, among the light. In addition, a third light L3 incident on a first side surface of the light absorbing layers 505 located the first surface S1 of the optical filter 1500 may be reflected from the third reflection pattern 509. The third reflection pattern 509 may include materials capable of reflecting a light.

For example, when the LCD device 1000 does not include the third reflection pattern 509, the third light L3 incident on the first side surface of the light absorbing layers 505 located in the first surface S1 may be absorbed. In this case, a light efficiency of the LCD device 1000 may be decreased.

As the LCD device 1000 includes the third reflection pattern 509, the third light L3 capable of being absorbed in the first side surface of the light absorbing layers 505 located in the first surface S1 may be reflected. The third light L3 reflected from the third reflection pattern 509 may be reflected from the reflection member 700. The third light L3 reflected from the reflection member 700 may be incident again on the optical filter 1500. Accordingly, compared to the LCD device 900, a light efficiency of the LCD device 1000 may be relatively increased.

Because the LCD device in accordance with exemplary embodiments includes an optical filter, the optical filter may reflect the first light having an angle of incidence, which is greater than the predetermined angle of incidence, on the first surface, and transmit the second light, which has an angle of incidence less than the predetermined angle of incidence, on the first surface. Accordingly, because the second light is transmitted only inside the light guide plate, the second light may be totally reflected, and a light leakage phenomenon may be relatively reduced at a portion that is adjacent to the light incident surface of the light guide plate.

The present invention may be applied to various display devices including an LCD device. For example, the present invention may be applied to vehicle-display device, a ship-display device, an aircraft-display device, portable communication devices, display devices for display or for information transfer, a medical-display device, etc.

Although certain exemplary embodiments have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A liquid crystal display (“LCD”) device comprising:
a light guide plate comprising a light incident surface and a light emission surface;
an optical film disposed in the light emission surface on the light guide plate, the optical film having a first refractive index;
a quantum dot film disposed on the optical film;
a display panel disposed on the quantum dot film, the display panel displaying an image;
a light source unit spaced apart from the light incident surface of the light guide plate, the light source unit emitting a light; and
an optical filter disposed in the light incident surface such that the optical filter is spaced apart from the light source unit, the optical filter reflecting a first light, which has an angle of incidence greater than a predetermined angle of incidence, among the light.

2. The LCD device of claim 1, wherein the optical filter transmits a second light, which has an angle of incidence less than the predetermined angle of incidence, among the light.

3. The LCD device of claim 1, where the optical filter comprises:
a first optical layer having the first refractive index; and
a second optical layer having a second refractive index that is greater than the first refractive index.

4. The LCD device of claim 3, wherein:
the optical filter comprises first and second optical layers; and
the first and second optical layers are repeatedly arranged such that the optical filter is configured to reflect the first light that has an angle of incidence greater than the predetermined angle of incidence and transmits the second light that has an angle of incidence less than the predetermined angle of incidence.

5. The LCD device of claim 3, wherein the optical filter comprises:
a first surface facing the light source unit; and
a second surface facing the light guide plate,
wherein the second surface of the optical filter is in direct contact with the light incident surface of the light guide plate.

6. The LCD device of claim 5, wherein an angle between a reference line normal to the first surface of the optical filter and an incident line of the incident light is defined as an angle of incidence of the light.

7. The LCD device of claim 1, wherein the light source unit is configured to emit a blue light.

8. The LCD device of claim 1, wherein the light guide plate is in direct contact with the optical film.

9. The LCD device of claim 1, further comprising a reflection member surrounding the optical filter and the light source unit.

10. The LCD device of claim 9, where the reflection member comprises:
a first reflection pattern disposed in a first surface of the light source unit; and
a second reflection pattern spaced apart from the light source unit, the second reflection pattern extending from an outer portion of the first reflection pattern in a direction, which is from the light source unit into the optical filter, such that the second reflection pattern is disposed to overlap at least a portion of the optical filter.

11. The LCD device of claim 10, wherein:
the reflection member surrounds the light source unit and the optical filter such that a light emitted in the light source unit does not escape to an outside; and
after a first light reflected from the optical filter is reflected from the reflection member, the first light is incident on the optical filter.

12. The LCD device of claim 1, wherein:
the optical filter has a first surface facing the light source unit and a second surface facing the light guide plate; and
the optical filter comprises:
a base layer; and
a plurality of light absorbing layers penetrating the base layer in a direction from the first surface in to the second surface.

13. The LCD device of claim 12, wherein the light absorbing layers are spaced apart from each other by a first distance, and a length of each of the light absorbing layers is a second distance that is different from the first distance, and
wherein the first and second distances are calculated according to Equation below:
$$d \leq \frac{tan {θ}_{c}}{t}$$
wherein d corresponds to the first distance, t corresponds to the second distance, and θ_{c} corresponds to a light angle of incidence with respect to the first surface.

14. The LCD device of claim 12, wherein each of the light absorbing layers includes:
a first side surface facing the light source unit; and
a second side surface facing the light guide plate;
wherein a first side of the base layer and the second side surface of the light absorbing layer are in direct contact with the light guide plate.

15. The LCD device of claim 14, further comprising:
a third reflection pattern disposed on the first side surface of each of the light absorbing layers; and
a reflection member surrounding the optical filter and the light source unit.

16. The LCD device of claim 1, wherein the light guide plate has a second refractive index that is greater than the first refractive index.

17. The LCD device of claim 16, wherein the light guide plate comprises a glass light guide plate.

18. The LCD device of claim 1, wherein the optical film comprises quantum dots, and the quantum dots comprise first quantum dot particles of a green color and second quantum dot particles of a red color.

19. The LCD device of claim 1, wherein the display panel comprises:
a lower substrate;
a pixel electrode disposed on the lower substrate;
a liquid crystal layer disposed on the pixel electrode;
a common electrode disposed on the liquid crystal layer;
a color filter disposed on the common electrode; and
an upper substrate disposed on the color filter.

20. The LCD device of claim 1, further comprising a polarizing film disposed between the optical film and the display panel.
